(19) United States
(12) Patent Application Publication
(10) Pub. No.: US 2026/0307374 A1
(43) Pub. Date: Oct. 8, 2026

(54) BIO-BASED COMPOSTABLE FILMS AND LAMINATES

(71) Applicant: MAGNERA CORPORATION, Charlotte, NC (US)

(72) Inventor: Linda Lin, Mason, OH (US)

(21) Appl. No.: 19/641,710

(22) Filed: Apr. 8, 2026

Related U.S. Application Data
(60) Provisional application No. 63/785,296, filed on Apr. 8, 2025.

(51) Int. Cl. B32B 27/20; B32B 5/02; B32B 27/12; B32B 27/36

(52) U.S. Cl. CPC B32B 27/20; B32B 5/022; B32B 5/024; B32B 27/12; B32B 27/36; B32B 2307/7163; B32B 2307/726; B32B 2437/00

(57) ABSTRACT

Bio-based compostable films including a combination of one or more polylatic acid (PLA) polymers and one or more amorphous polyhydroxyalkonate (aPHA) polymers are provided. The compostable films provide desirable breathability, strength, and/or hydrohead. Hygiene and healthcare articles including the compostable films are also provided.

### CROSS REFERENCE TO RELATED APPLICATIONS

This application claims priority from U.S. Provisional Application No. 63/785,296, filed Apr. 8, 2025, the entire contents of which is hereby incorporated by reference in its entirety.

### TECHNICAL FIELD

Embodiments of the presently-disclosed invention relate generally to bio-based compostable films, in which the compostable films include a combination of one or more polylatic acid (PLA) polymers and one or more amorphous polyhydroxyalkonate (aPHA) polymers, having desirable breathability, strength, and/or hydrohead.

### BACKGROUND

Hygienic products, such as diapers, include a backsheet that are typically composed of one or more film layers or laminates of a film, such as a polyethylene film, and a nonwoven fabric. The backsheet provides a barrier to liquid, such as urine, blood, body liquid, etc. In some instances, the film of the backsheet may comprise a polyethylene film that may be either microporous or nonporous. These films provides adequate barrier to water, blood, and saline, but they also undesirably prevent air ventilation. Consequently, moisture or wetness gets trapped against the skin of wearer, which is likely to cause a diaper rash, irritated skin, chafing, etc. Furthermore, the use of petroleum-based materials, such as polyethylene and polypropylene, in microporous films requires formulating the film layer with inorganic particles followed by incremental stretching to activate the film and provide some level of moisture vapor transmission for comfort and skin health. These films, however, are not compostable.

Bio-based polyethylene and polypropylene exist but they are also not compostable. Compostable polymer blends based on polylactic acid (PLA) and polybutylene adipate terephthalate (PBAT) are also available, but they are not completely bio-based.

In this regard, there remains a need in the art for a bio-based compostable film that provides a desirable level of breathability, hydrohead, and/or strength suitable for a variety of hygiene and healthcare applications.

### SUMMARY OF INVENTION

One or more embodiments of the invention may address one or more of the aforementioned problems. Certain embodiments according to the invention provide a bio-based compostable film comprising at least a first layer comprising (i) a polymer component comprising (a) one or more polylatic acid (PLA) polymers, and (b) one or more amorphous polyhydroxyalkonate (aPHA) polymers; and optionally (ii) an additive component. In accordance with certain embodiments of the invention, the film and/or the first layer has a water vapor transmission rate (WVTR) of at least about 500 MOCON (g/m²/24 hours) per INDA IST 70.4 (08), such as at least about any of the following: 500, 550, 600, 650, 700, 750, 800, and 1000 MOCON (g/m²/24 hours) per INDA IST 70.4 (08), and/or at most about any of the following: 3000, 2800, 2500, 2200, 2000, 1900, 1800, 1500, 1200, and 1000 MOCON (g/m²/24 hours) per INDA IST 70.4 (08). In accordance with certain embodiments of the invention, the polymer component and/or the first layer has a bio-based carbon content from 75 to 100% by weight per ASTM D6866, such as at least about 75, 80, 85, and 90% by weight per ASTM D6866, and/or at most about any of the following: 100, 99, 98, 96, 95, 92, and 90% by weight per ASTM D6866.

In another aspect, the present invention provides an article including (i) a backsheet comprising a compostable film, such as those described and disclosed herein; (ii) a liquid permeable top sheet; and (iii) an absorbent core, wherein the absorbent core is located directly or indirectly between the top sheet and the backsheet. For example, the article may comprises a feminine hygiene product, a diapers, or an adult incontinence product. Alternatively, the compostable film may be used alone as a barrier leg cuff for a diaper.

In another aspect, the present invention provides a protective article comprising a compostable film, such as those described and disclosed herein. For example, the protective article may comprise a surgical drape or surgical clothing article.

In yet another aspect, the present invention provides a method of forming a compostable film, comprising the following: (A) forming a polymeric melt composition comprising (i) a polymer component comprising (a) one or more polylatic acid (PLA) polymers, and (b) one or more polyhydroxyalkonate (aPHA) polymers; and optionally (ii) an additive component; and (B) forming at least a first film layer from the polymeric melt composition, such as by a cast film process or a blown film process.

In another aspect, the present invention provides a laminate comprising a compostable film, such as those described and disclosed herein, bonded directly or indirectly to a substrate, such as a woven or nonwoven fabric or a secondary film.

### DETAILED DESCRIPTION

The invention now will be described more fully hereinafter. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

The presently-disclosed invention relates generally to bio-based compostable films that include a combination of one or more polylatic acid (PLA) polymers and one or more amorphous polyhydroxyalkonate (aPHA) polymers, while exhibiting a desired level of breathability suitable for a variety of hygiene and healthcare products/applications. In this regard, the films provide breathability to allow sufficient passage of water vapor passage while simultaneously providing a desired level of hydrohead to mitigate the passage of liquids therethrough. The compostable films, in accordance with certain embodiments of the invention, can be derived from more sustainable polymer mixtures or blends of PLA and aPHA without the requirement of incremental stretching. For instance, compostable film may provide sufficient water vapor transmission rates (WVTR) without being “activated” by incremental stretching. Accordingly, the compostable films may be provided in a non-stretched state and provide the desired WVTR in accordance with certain embodiments of the invention. However, certain embodiments of the invention may include the use of a filler material dispersed throughout the body or thickness of the film followed by incremental stretching to provide even greater WVTR values. In accordance with certain embodiments of the invention, the compostable films disclosed and described herein meets the compostability and biodegrability standards of ASTM D6400.

In accordance with certain embodiments of the invention, the compostable films may be monolayer films or multicomponent films having a plurality of individual compostable layers stacked upon each other. Additionally or alternatively, the compostable films may be attached (e.g., thermally and/or adhesively bonded) to one or more non-compostable films, such as petroleum-based films. The petroleum-based films may be microporous films and/or monolithic films. Additionally or alternatively, the compostable films may be attached to one or more fabric layers (e.g., woven or nonwoven layers). For instance, the fabric layer(s) may comprises a spunbond layer, a meltblown layer, a carded bonded layer or staple fibers, a hydroentangled layer, or any combination thereof. The nonwoven layer(s) may be formed of a bio-based polymer(s) that is a biodegradable and/or compostable material, such as PLA and/or PHA. In accordance with certain embodiments of the invention, the nonwoven layer(s) may include a blend or mixture of the one or more bio-based polymers with one or more petroleum-based materials, such as polyethylene and polypropylene. For instance, a plurality of fibers defining the nonwoven layer(s) may comprise from about 10 to about 100% by weight of one or more bio-based polymers, such as at least about any of the following: 10, 20, 30, 40, and 50% by weight, and/or at most about any of the following: 100, 95, 90, 85, 80, 75, 70, 65, 60, 55, and 50% by weight.

The term “bio-based”, as used herein, may comprise polymers derived fully or partly from bio-based resources, such as plants or bacteria. Bio-based should not be confused with biodegradable or compostable, which are two end-of-life scenarios. However, some bio-based polymers are biodegradable and/or compostable while others are not, as shown in Table 1. In this regard, “bio-based” simply refers to the origin of the monomers or polymers.

TABLE 1

| | | Petroleum- | | Biodegradable or |
|---|---|---|---|---|
| Polymer | Abbreviation | based | Bio-based | compostable |
| Polyethylene | PE | Yes | Available | No |
| Polypropylene | PP | Yes | Available | No |
| Polystyrene | PS | Yes | No | No |
| Polyvinylchloride | PVC | Yes | Available | No |
| Polyethylene terephthalate | PET | Yes | Partly bio-based available | No |
| Ethylene vinyl alcohol | EVOH | Yes | No | No |
| Polyvinylidene chloride | PVDC | Yes | No | No |
| Polyamide 6 (nylon 6) | PA6 | Yes | No | No |
| Polybutylene adipate terephthalate | PBAT | Yes | No | Yes |
| Polyvinyl alcohol | PVOH | Yes | No | Yes |
| Polyglycolic acid | PGA | Yes | No | Yes |
| polycaprolactone | PCL | Yes | No | Yes |
| Polybutylene succinate | PBS | Partly | Partly | Yes |
| Polyamide 11 | PA11 | No | Yes | No |
| Polylactic acid | PLA | No | Yes | Yes |
| Polyhydroxyalkanoate | PHA | No | Yes | Yes |
| Starch | | No | Yes | Yes |
| Cellulose-based | | No | Yes | Yes |

The term “polyhydroxyalkanoates (PHAs)” may broadly comprise renewable, thermoplastic aliphatic polyesters which may be produced by polymerization of the respective monomer hydroxy aliphatic acids (including dimers of the hydroxy aliphatic acids), by bacterial fermentation of starch, sugars, lipids, etc. PHAs may include, by way of example only, one or more of: poly-beta-hydroxybutyrate (PHB) (also known as poly-3-hydroxybutyrate); poly-alpha-hydroxybutyrate (also known as poly-2-hydroxybutyrate); poly-3-hydroxypropionate; poly-3-hydroxyvalerate; poly-4-hydroxybutyrate; poly-4-hydroxyvalerate; poly-5-hydroxyvalerate; poly-3-hydroxyhexanoate; poly-4-hydroxyhexanoate; poly-6-hydroxyhexanoate; polyhydroxybutyrate-valerate (PHBV); polyglycolic acid; polylactic acid (PLA), etc., including copolymers, blends, mixtures, combinations, etc., of different PHA polymers, etc.

The term “amorphous PHA (aPHA)”, as used herein, may comprise a bio-based polymer that belongs to the family of PHAs that may be considered as a non-crystalline or amorphous polymer, meaning that it lacks the highly ordered structure found in semi-crystalline polymers. In this regard, aPHA exhibits a notably lower glass transition temperature than crystalline or semi-crystalline PHAs. PHAs formed from one or more medium chain length PHA (mcl-PHA) monomers having from 6 to 14 carbon atoms as well as long chain length PHA (lcl-PHA) monomers having greater than 14 carbons generally provide a more amorphous polymer that exhibits increased ductility, elasticity, and/or flexibility. By way of example only, aPHA may have a glass transition temperature from about −60° C. to −5° C. as determined by ASTM E1356, such as at least about any of the following: −60° C., −50° C., −40° C., −30° C. and −25° C., and/or at most about any of the following: −5° C., −10° C., 15° C., −20° C., and −25° C. as determined by ASTM E1356.

The term “polylactic acid or polylactide (PLA)”, as used herein, may comprise a renewable, biodegradable, thermoplastic, aliphatic polyester formed from a lactic acid or a source of lactic acid, for example, renewable resources such as corn starch, sugarcane, etc. The term PLA may refer to all stereoisomeric forms of PLA including L- or D-lactides, and racemic mixtures comprising L- and D-lactides. For example, PLA may include D-polylactic acid, L-polylactic acid (also known as PLLA), D,L-polylactic acid, meso-polylactic acid, as well as any combination of D-polylactic acid, L-polylactic acid, D,L-polylactic acid and meso-polylactic acid. PLAs useful herein may have, for example only, a number average molecular weight in the range of from about 15,000 and about 300,000.

The term “filler”, as used herein, may comprise particles or aggregates of particles and other forms of materials that can be added to a polymeric blend. According to certain embodiments of the invention, a filler will not substantially chemically interfere with or adversely affect the extruded film. According to certain embodiments of the invention, the filler is capable of being uniformly dispersed throughout the film or a layer comprised in a multilayer film. Fillers may comprise particulate inorganic materials such as, for example, calcium carbonate, various kinds of clay, alumina, barium sulfate, sodium carbonate, magnesium sulfate, titanium dioxide, zeolites, aluminum sulfate, cellulose-type powders, magnesium sulfate, magnesium carbonate, barium carbonate, kaolin, mica, carbon, calcium oxide, magnesium oxide, aluminum hydroxide, glass particles, and the like, and organic particulate materials such as high-melting point polymers (e.g., TEFLON® and KEVLAR® from E.I. DuPont de Nemours and Company), pulp powder, wood powder, cellulose derivatives, chitin and chitin derivatives, and the like. Filler particles may optionally be coated with a fatty acid, such as stearic acid or reduced stearic acid, or a larger chain fatty acid, such as behenic acid. Without intending to be bound by theory, coated filler particles may facilitate the free flow of the particles (in bulk) and their ease of dispersion into the polymer matrix, according to certain embodiments of the invention. Moreover, selective coatings applied to the surface of the filler material may facilitate the formation of pores in a resulting film layer, such as providing the filler with a dissimilar polarity comparted to the polymer matrix (e.g., polymer component) in which the filler is dispersed.

Certain embodiments according to the invention provide a bio-based compostable film comprising at least a first layer comprising (i) a polymer component comprising (a) one or more polylatic acid (PLA) polymers, and (b) one or more amorphous polyhydroxyalkonate (aPHA) polymers; and optionally (ii) an additive component. In accordance with certain embodiments of the invention, the film and/or the first layer has a water vapor transmission rate (WVTR) of at least about 500 MOCON (g/m²/24 hours) per INDA IST 70.4 (08), such as at least about any of the following: 500, 550, 600, 650, 700, 750, 800, and 1000 MOCON (g/m²/24 hours) per INDA IST 70.4 (08), and/or at most about any of the following: 3000, 2800, 2500, 2200, 2000, 1900, 1800, 1500, 1200, and 1000 MOCON (g/m²/24 hours) per INDA IST 70.4 (08). In accordance with certain embodiments of the invention, the polymer component and/or the first layer has a bio-based carbon content from 75 to 100% by weight per ASTM D6866, such as at least about 75, 80, 85, and 90% by weight per ASTM D6866, and/or at most about any of the following: 100, 99, 98, 96, 95, 92, and 90% by weight per ASTM D6866.

The polymer component may comprise a mixture of the one or more aPHA polymers and the one or more PLA polymers having at least two distinct glass transition temperatures (e.g., the aPHA polymers may not be miscible with the PLA polymer(s) and each provides a different glass transition temperature). For example, the aPHA polymer(s) of the polymer component may be associated with a first glass transition temperature and the PLA polymer(s) of the polymer component may be associated with a second glass transition temperature, in which the first glass transition temperature is lower than the second glass transition temperature. In accordance with certain embodiments of the invention, a temperature difference between the first glass transition temperature and the second glass transition temperature may be from about 70 to about 150° C., such as at least about any of the following: 70° C., 75° C., 80° C., 85° C., 90° C., 95° C., and 100° C., and/or at most about any of the following: 150° C., 140° C., 130° C., 120° C., 110° C., and 100° C.

In accordance with certain embodiments of the invention, the first layer or film (e.g., multiple bio-based film layers forming the film) includes the additive component, and the additive component comprises filler material comprising a plurality of particulates dispersed throughout the polymer component. For example, the filler material may comprise any of the materials described above. In accordance with certain embodiments of the invention, the filler m material comprises a plurality of organic and/or inorganic particulates, such as a plurality of calcium carbonate (CaCO₃) particulates.

The filler material, in accordance with certain embodiments of the invention, may be inherently or rendered less polar than the one or more PLA polymers and/or the one or more aPHA polymers. For instance, the filler material may comprise a surface coating disposed thereon that renders the filler material less polar than the one or more PLA polymers and/or the one or more aPHA polymers. The difference in polarity between the filler material (e.g., particles) and the polymer component (e.g., polymer matrix comprising the PLA and PHA polymers) may facilitate the formation of micron-sized pores in the formed film or first layer upon being subjected to incremental stretching.

In accordance with certain embodiments of the invention, the filler material comprises from about 1 to about 50% by weight of the first layer or film (e.g., for a multilayer film), such as at least about any of the following: 1, 3, 5, 8, 10, 12, 15, 18, 20, 22, 25, 28, and 30% by weight of the first film layer or film (e.g., for a multilayer film), and/or at most about any of the following: 50, 48, 45, 42, 40, 38, 35, 32, and 30% by weight of the first film layer or film (e.g., for a multilayer film). Alternatively, the first layer or film (e.g., for a multilayer film) may be devoid of a filler material.

In accordance with certain embodiments of the invention, the compostable film may provide any of the previously noted MVTR values despite being devoid of micropores. For instance, compostable films in accordance with certain embodiments of the invention need not be activated (e.g., include a pore forming filler and subjected to incremental stretching to developing a network of micropores that impart breathability). Although not wishing to be bound by the following theory, but it is believed that the polar nature of the polymers facilitate or allow the passage of water vapor therethrough without the need for the presence of micropores. The examples section of the present disclosure highlight this aspect of the present invention.

In accordance with certain embodiments of the invention, the one or more PLA polymers comprises from about 30 to about 80% by weight of the polymer component, such as at least about any of the following: 30, 35, 40, 45, and 50% by weight of the polymer component, and/or at most about any of the following: 80, 75, 70, 65, 60, 55, and 50% by weight of the polymer component. Additionally or alternatively, the one or more PLA polymers comprises from about 30 to about 80% by weight of the first layer or film (e.g., for a multilayer film), such as at least about any of the following: 30, 35, 40, 45, and 50% by weight of the first layer, and/or at most about any of the following: 80, 75, 70, 65, 60, 55, and 50% by weight of the first layer or film (e.g., for a multilayer film).

In accordance with certain embodiments of the invention, the one or more aPHA polymers comprises from about 10 to about 70% by weight of the polymer component, such as at least about any of the following: 10, 15, 20, 25, 30, 35, and 40% by weight of the polymer component, and/or at most about any of the following: 70, 65, 60, 55, 50, 45, and 40% by weight of the polymer component. Additionally or alternatively, the one or more aPHA polymers comprises from about 10 to about 70% by weight of the first layer or film (e.g., for a multilayer film), such as at least about any of the following: 10, 15, 20, 25, 30, 35, and 40% by weight of the first layer, and/or at most about any of the following: 70, 65, 60, 55, 50, 45, and 40% by weight of the first layer or film (e.g., for a multilayer film).

The PHA content of the compostable film may include one or more aPHA polymers, in accordance with certain embodiments of the invention. For instance, the PHA content of the compostable film may comprise a blend of a plurality of aPHA polymers and optionally one or more non-amorphous PHA polymers as long at the overall blend of PHA polymers is considered amorphous in the aggregate based on the blend's glass transition temperature as noted previously. In this regard, the blend of the plurality of PHA polymers (whether completely aPHA polymers or a combination of aPHA and PHA polymers) may include one or more PHA polymers having one or more short chain length PHA (scl-PHA) monomers, and/or one or more medium chain length PHA (mcl-PHA) monomers, and/or one or more long chain length PHA (lcl-PHA) monomers. By way of example only, the total PHA content may comprise from about 10 to about 100% by weight of aPHA polymers, such as at least about any of the following: 10, 20, 30, 40, and 50% by weight, and/or at most about any of the following: 100, 95, 90, 85, 80, 75, 70, 65, 60, 55, and 50% by weight.

By way of example, the one or more aPHA polymers may include at least a first aPHA polymer comprising one or more medium chain length PHA (mcl-PHA) monomers having from 6 to 14 carbon atoms, such as at least about any of the following: 6, 7, 8, 9 and 10 carbon atoms, and/or at most about any of the following: 14, 13, 12, 11, and 10 atoms. Additionally or alternatively, the first aPHA polymer comprises from about 10 to about 100% by weight of the one or more mcl-PHA monomers, such as at least about any of the following: 10, 15, 20, 25, 30, 35, 40, 45, and 50% by weight of the one or more mcl-PHA monomers, and/or at most about any of the following: 100, 95, 90, 85, 80, 75, 70, 65, 60, 55, and 50% by weight of the one or more mcl-PHA monomers. The first aPHA polymer, for example, additionally or alternatively include one or more long chain length PHA (lcl-PHA) monomers having greater than 14 carbon atoms, such as at least about any of the following: 15, 16, 18, and 20 carbon atoms, and/or at most about any of the following: 30, 28, 26, 24, 22, and 20 carbon atoms. Additionally or alternatively, the first aPHA polymer comprises from about 10 to about 100% by weight of the one or more lcl-PHA monomers, such as at least about any of the following: 10, 15, 20, 25, 30, 35, 40, 45, and 50% by weight of the one or more lcl-PHA monomers, and/or at most about any of the following: 100, 95, 90, 85, 80, 75, 70, 65, 60, 55, and 50% by weight of the one or more lcl-PHA monomers. As noted above, the one or more aPHA polymers may comprise a mixture or blend of a plurality of different aPHA polymers including the first aPHA polymer, wherein each of the plurality of different aPHA polymers has one or more mcl-PHA monomers and/or one or more lcl-PHA monomers, such as at least about any of the following: 10, 15, 20, 25, 30, 35, 40, 45, and 50% by weight of the one or more mcl-PHA monomers and/or lcl-monomers, and/or at most about any of the following: 100, 95, 90, 85, 80, 75, 70, 65, 60, 55, and 50% by weight of the one or more mcl-PHA monomers and/or lcl-PHA monomers. Additionally or alternatively, the first aPHA polymer may comprise one or more short chain length PHA (scl-PHA) monomers having from 3, 4, or 5 carbon atoms. For example, the first aPHA polymer may comprise from 0 to about 90% by weight of the one or more scl-PHA monomers, such as at least about any of the following: 0, 5, 10, 15, 20, 25, 30, 35, 40, 45, and 50% by weight of the one or more scl-PHA monomers, and/or at most about any of the following: 90, 85, 80, 75, 70, 65, 60, 55, and 50% by weight of the one or more scl-PHA monomers. Alternatively, the one or more aPHA polymers may be devoid of scl-PHA monomers.

In accordance with certain embodiments of the invention, the one or more aPHA polymers may have total content of mcl-PHA monomers plus lcl-PHA monomers (e.g., the aggregate of mcl-PHA monomers and lcl-PHA monomers) from about 10 to 100% by number of total monomer content, such as at least about any of the following: 10, 15, 20, 25, 30, 35, 40, 45, 50, 55, and 60% by number, and/or at most about any of the following: 100, 95, 90, 85, 80, 75, 70, 65, and 60% by number. Additionally or alternatively, the total PHA content of the compostable film may have total content of mcl-PHA monomers plus lcl-PHA monomers (e.g., the aggregate of mcl-PHA monomers and lcl-PHA monomers) from about 10 to 100% by number of total monomer content, such as at least about any of the following: 10, 15, 20, 25, 30, 35, 40, 45, 50, 55, and 60% by number, and/or at most about any of the following: 100, 95, 90, 85, 80, 75, 70, 65, and 60% by number.

In accordance with certain embodiments of the invention, the film may be a monolayer film consisting of the first layer. Alternatively, the film may be a multilayer film including the first layer. For example, the first layer may be located directly or indirectly between a first outermost layer and a second outermost layer. In accordance with certain embodiments of the invention, the first outermost layer and/or the second outermost layer may comprise (i) a respective polymer component comprising (a) one or more polylatic acid (PLA) polymers, and (b) one or more polyhydroxyalkonate (aPHA) polymers; and optionally (ii) a respective additive component. By way of example only, the first layer, the first outermost layer, and the second outermost layer have an identical composition.

In accordance with certain embodiments of the invention, the film may have a total thickness from about 10 to about 100 microns, such as at least about any of the following: 10, 12, 15, 18, 20, 22, 25, 28, 30, 35, and 40 microns, and/or at most about any of the following: 100, 90, 80, 70, 60, and 50 microns. Additionally or alternatively, the film may have a basis weight from about 10 to about 100 grams-per-meter-squared (gsm), such as at least about any of the following: 10, 12, 15, 18, 20, 22, 25, 28, and 30 gsm, and/or at most about any of the following: 100, 90, 80, 70, 60, 50, 40, and 30 gsm. In this regard, the foregoing values may apply to a monolayer film and for a multilayer film.

The film, in accordance with certain embodiments of the invention, may be a multicomponent film and an average thickness of each individual layer comprises from about 5 to about 30 microns, such as at least about any of the following: 5, 8, 10, 12, and 15 microns, and/or at most about any of the following: 30, 28, 25, 22, 20, 18, and 15 microns. Additionally or alternatively, the multilayer film may include from 2 to 10 individual layers, such as at least about any of the following: 2, 3, 4, and 5 individual layers, and/or at most about any of the following: 10, 9, 8, 7, 6, and 5 individual layers.

In accordance with certain embodiments of the invention, the first layer or film may include a plurality of pores located throughout a body or thickness of the first layer or film. For instance, the plurality of pores may define a void volume of the first layer or film, wherein the void volume comprises from about 1 to about 40% by volume of the total volume of the first layer or film, such as at least about any of the following: 1, 3, 5, 8, 10, 12, 15, 18, and 20% by volume of the total volume of the first layer or film, and/or at most about any of the following: 40, 38, 35, 32, 30, 28, 25, 22, and 20% by volume of the total volume of the first layer or film.

In accordance with certain embodiments of the invention, the first layer or film may have an opacity percentage from about 15 to about 80% per ASTM D1003, such as at least about any of the following: 15, 18, 20, 25, 30, 35, 40, 45, and 50% per ASTM D1003, and/or at most about any of the following: 80, 75, 70, 65, 60, 55, and 50% per ASTM D1003.

In accordance with certain embodiments of the invention, the first layer or film may have a machine direction elongation at break from about 50 to 300% per ASTM D882, such as at least about any of the following: 50, 60, 70, 80, 90, 100, 110, 120, 130, 140, and 150% per ASTM D882, and/or at most about any of the following: 300, 280, 250, 220, 200, 190, 180, 170, 160, and 150% per ASTM D882. Additionally or alternatively, the first layer or film may have a cross direction elongation at break from about 30 to 300% per ASTM D882, such as at least about any of the following: 30, 40, 50, 60, 70, 80, 90, 100, 110, 120, 130, 140, and 150% per ASTM D882, and/or at most about any of the following: 300, 280, 250, 220, 200, 190, 180, 170, 160, and 150% per ASTM D882.

In accordance with certain embodiments of the invention, the first layer or film may have a machine direction tensile strength at break from about 800 to about 3000 g/in per ASTM D882, such as at least about any of the following: 800, 820, 850, 880, 1000, 1200, 1400, 1500, 1600, 1800, and 2000 g/in per ASTM D882, and/or at most about any of the following: 3000, 2800, 2600, 2500, 2400, 2200, and 2000 g/in per ASTM D882. Additionally or alternatively, the first layer or film may have a cross direction tensile strength at break from about 500 to about 1500 g/in per ASTM D882, such as at least about any of the following: 500, 520, 550, 580, 600, 650, 700, 750, 800, and 850 g/in per ASTM D882, and/or at most about any of the following: 1500, 1400, 1200, 1000, 900, and 850 g/in per ASTM D882.

In accordance with certain embodiments of the invention, the first layer or film may have a hydrohead from about 80 to about 1000 mbar determined per EN 20811, such as at least about any of the following: 80, 90, 100, 100, 110, 120, 130, 140, and 150 mbar determined per EN 20811, and/or at most about any of the following: 1000, 800, 600, 400, 380, 360, 350, 340, 320, 300, 280, 260, 250, 240, 220, 200, 190, 180, 170, 160, and 150 mbar determined per EN 20811.

In another aspect, the present invention provides an article including (i) a backsheet comprising a compostable film, such as those described and disclosed herein; (ii) a liquid permeable top sheet; and (iii) an absorbent core, wherein the absorbent core is located directly or indirectly between the top sheet and the backsheet. For example, the article may comprises a feminine hygiene product, a diapers, or an adult incontinence product. Alternatively, the compostable film may be used alone as a barrier leg cuff for a diaper.

In another aspect, the present invention provides a protective article comprising a compostable film, such as those described and disclosed herein. For example, the protective article may comprise a surgical drape, surgical clothing article, garment, or a portion thereof. The protective article, for example, may comprise one or more nonwoven fabrics attached to the compostable film as noted above. For instance, the one or more nonwoven fabrics may be thermally bonded to the compostable film and/or adhesively bonded to the compostable film via an adhesive layer, which may be continuous or discontinuous. The use of a discontinuous adhesive layer may be preferred to avoid negatively impacting the breathability of the resulting material. The adhesive layer, in accordance with certain embodiments of the invention, may comprise a discontinuous pattern of an adhesive composition, in which the adhesive composition of the discontinuous pattern covers from about 2% to about 40% of a first surface of the film, such as at least about any of the following: 2, 3, 5, 8, 10, 12, 15, 18, 20, and 22% of the first surface, and/or at most about any of the following: 40, 38, 35, 32, 30, 28, 25, 24, and 22% of the first surface. By way of example only, the discontinuous pattern may comprises a plurality of dots, a plurality of hollow circular shapes, a plurality of straight lines, a plurality of non-linear lines, or any combinations thereof. In accordance with certain embodiments of the invention, the discontinuous pattern comprises a grid formation defining a plurality of islands that are devoid of the adhesive composition.

The adhesive layer, in accordance with certain embodiments of the invention, may be applied by roll coating, knife coating, die coating, spray coating. Additionally or alternatively, the adhesive layer may comprise, for example only, polyolefin adhesives, polyamide adhesives, acrylic acid adhesive, bio-based adhesives, synthetic rubber based adhesives, a polyurethane reactive adhesive, and combinations thereof. In accordance with certain embodiments of the invention, the bio-based adhesive is a compostable adhesive. In accordance with certain embodiments of the invention, compostable adhesive compositions may be formulated with organic materials that break down into natural elements within a certain time frame, and generally having no adverse effect on soil health.

In accordance with certain embodiments of the invention, the adhesive composition may comprises from 10 to 100% by weight of a compostable adhesive composition, such as at least about any of the following: 10, 20, 30, 40, and 50% by weight, and/or at most about any of the following: 100, 95, 90, 85, 80, 75, 70, 65, 60, 55, and 50% by weight.

In accordance with certain embodiments of the invention, the article may be from about 50 to 100% compostable, such as at least about any of the following: 50, 60, 70, and 75% by weight compostable, and/or at most about any of the following: 100, 99, 98, 95, 90, 85, 80, and 75% by weight compostable.

In yet another aspect, the present invention provides a laminate comprising a compostable film, such as those described and disclosed herein, and a substrate in which the compostable film is directly or indirectly bonded to the substrate. In accordance with certain embodiments of the invention, the substrate comprises at least one woven fabric and/or at least one nonwoven fabric. For instance, the compostable film includes a first side and an opposite second side, and the first side of the compostable film may be bonded directly or indirectly to a first nonwoven fabric, and optionally the second side of the compostable film may be bonded directly or indirectly to a second nonwoven fabric. The first nonwoven fabric may comprise a spunbond layer, a meltblown layer, a carded bonded layer or staple fibers, a hydroentangled layer, a cellulosic fiber containing layer, a high-loft layer, or any combination thereof. By way of example only, the first nonwoven fabric may comprise a spunbond-meltblown-spunbond structure. As further non-limiting example, the first nonwoven fabric may comprise a first physically entangled, such as hydroentangled, nonwoven fabric comprising at least one spunbond layer, and at least one cellulosic fiber-contenting layer physically entangled with each other. In accordance with certain embodiments of the invention, the first physically entangled nonwoven fabric may comprise a first outermost spunbond layer, a second outermost spunbond layer, and at least one interior cellulosic-fiber containing layer located between the first outermost spunbond layer and the second outermost layer, in which the first outermost spunbond layer, the at least one interior cellulosic-fiber containing layer, and the second outermost spunbond layer are physically entangled together.

In accordance with certain embodiments of the invention, the second side of the compostable film may be bonded directly or indirectly to the second nonwoven fabric. For example, the second nonwoven fabric may comprise a spunbond layer, a meltblown layer, a carded bonded layer or staple fibers, a hydroentangled layer, a cellulosic fiber containing layer, a high loft layer, or any combination thereof. By way of example only, the second nonwoven fabric may comprise a spunbond-meltblown-spunbond structure. As another non-limiting example, the second nonwoven fabric may comprise a second physically entangled, such as hydroentangled, nonwoven fabric comprising at least one spunbond layer, and at least one cellulosic fiber-contenting layer physically entangled with each other. In accordance with certain embodiments of the invention, the second physically entangled nonwoven fabric may comprise a first outermost spunbond layer, a second outermost spunbond layer, and at least one interior cellulosic-fiber containing layer located between the first outermost spunbond layer and the second outermost layer, in which the first outermost spunbond layer, the at least one interior cellulosice-fiber containing layer, and the second outermost spunbond layer are physically entangled together.

In accordance with certain embodiments of the invention, the first nonwoven fabric and/or the second nonwoven fabric may respectively include a plurality of fibers comprising a polymer component and an optional additive component, in which the polymer component comprises one or more bio-based polymers, such as from 10 to 100% by weight of one or more bio-based polymers, such as at least about any of the following: 10, 20, 30, 40, and 50% by weight, and/or at most about any of the following: 100, 95, 90, 85, 80, 75, 70, 65, 60, 55, and 50% by weight. The one or more bio-based polymers may comprise one or more PLA polymers, one or more PHA polymers (amorphous or non-amorphous), or any combination thereof.

The polymer component, in accordance with certain embodiments of the invention, may comprise a blend or mixture of the one or more bio-based polymers and one or more petroleum-based polymers, such as one or more polyolefin polymers, one or more polyester polymers, one or more polyamide polymers, or any combination thereof. The one or more petroleum-based polymers may comprise a polypropylene, a polypropylene copolymer, a polyethylene, a polyethylene copolymer, or any combination thereof.

In accordance with certain embodiments of the invention, the first nonwoven fabric, the second nonwoven fabric, or both independent from each other may have a basis weight from about 5 to about 200 gsm, such as at least about any of the following: 5, 10, 15, 20, 30, 50, 80, and 100 gsm, and/or at most about any of the following: 200, 180, 160, 140, 120, and 100 gsm.

In accordance with certain embodiments of the invention, the substrate may comprises at least one secondary film. For example, the at least one secondary film comprises a single monolayer film, which may be a microporous film or a monolithic film (e.g., devoid of micropores but allows passage of water vapor therethrough due use of a breathable polymer). Alternatively, the at least one secondary film comprises a multilayer film, in which each layer may be a microporous film layer or a monolithic film layer. For example, the multilayer film may include a first outermost skin layer, and a base layer, in which the base layer is located proximate to or adjacent the compostable film. In accordance with certain embodiments of the invention, the multilayer film may include a second outermost skin layer, in which the base layer is located directly or indirectly between the first outermost skin layer and the second outermost layer, and wherein the second outermost skin layer is located proximate to or adjacent the compostable film.

The at least one secondary film, in accordance with certain embodiments of the invention, may have a total thickness from 5 to about 100 microns, such as at least about any of the following: 5, 8, 10, 15, 18, 20, 25, 30, 40 and 50 microns, and/or at most about any of the following: 100, 80, 60, and 50 microns.

In accordance with certain embodiments of the invention, the at least one secondary film may comprise a non-compostable film, such as a petroleum-based material. The petroleum-based material may comprise a wide variety of polymeric compositions including, but not limited to polyolefin polymers (e.g., polypropylene, polyethylene, copolymers of polypropylene and/or polyethylene, etc.), polyester polymers, polyamide polymers, or any combination thereof.

The compostable film, in accordance with certain embodiments of the invention, may be directly bonded to the substrate via one or more thermal bonds, such as by thermal point bonding, ultrasonic bonding, and thermal area bonding. Additionally or alternatively, the compostable film is melt extruded directly onto the substrate, in which the molten or semi-molten state of the compostable film bonds directly with the substrate upon cooling.

In accordance with certain embodiments of the invention, the compostable film may be indirectly bonded to the substrate by a continuous or discontinuous adhesive layer comprising an adhesive composition. For example, the use of a discontinuous adhesive layer may be preferred to avoid negatively impacting the breathability of the resulting material. The adhesive layer, in accordance with certain embodiments of the invention, may comprise a discontinuous pattern of an adhesive composition, in which the adhesive composition of the discontinuous pattern covers from about 2% to about 40% of a respective surface of the compostable film, such as at least about any of the following: 2, 3, 5, 8, 10, 12, 15, 18, 20, and 22% of a respective surface, and/or at most about any of the following: 40, 38, 35, 32, 30, 28, 25, 24, and 22% of the a respective surface. By way of example only, the discontinuous pattern may comprises a plurality of dots, a plurality of hollow circular shapes, a plurality of straight lines, a plurality of non-linear lines, or any combinations thereof. In accordance with certain embodiments of the invention, the discontinuous pattern comprises a grid formation defining a plurality of islands that are devoid of the adhesive composition.

The adhesive layer, in accordance with certain embodiments of the invention, may be applied by roll coating, knife coating, die coating, spray coating. Additionally or alternatively, the adhesive layer may comprise, for example only, polyolefin adhesives, polyamide adhesives, acrylic acid adhesive, bio-based adhesives, synthetic rubber based adhesives, a polyurethane reactive adhesive, and combinations thereof. In accordance with certain embodiments of the invention, the bio-based adhesive is a compostable adhesive. In accordance with certain embodiments of the invention, the bio-based adhesive is a compostable adhesive. In accordance with certain embodiments of the invention, compostable adhesive compositions may be formulated with organic materials that break down into natural elements within a certain time frame, and generally having no adverse effect on soil health.

In accordance with certain embodiments of the invention, the adhesive composition may comprises from 10 to 100% by weight of a compostable adhesive composition, such as at least about any of the following: 10, 20, 30, 40, and 50% by weight, and/or at most about any of the following: 100, 95, 90, 85, 80, 75, 70, 65, 60, 55, and 50% by weight.

In accordance with certain embodiments of the invention, the laminate may be from about 50 to 100% compostable, such as at least about any of the following: 50, 60, 70, and 75% by weight compostable, and/or at most about any of the following: 100, 99, 98, 95, 90, 85, 80, and 75% by weight compostable.

In yet another aspect, the present invention provides a method of forming a compostable film, comprising the following: (A) forming a polymeric melt composition comprising (i) a polymer component comprising (a) one or more polylatic acid (PLA) polymers, and (b) one or more polyhydroxyalkonate (aPHA) polymers; and optionally (ii) an additive component; and (B) forming at least a first film layer from the polymeric melt composition, such as by a cast film process or a blown film process. In accordance with certain embodiments of the invention, the polymeric melt composition may be any of the compositions described and disclosed herein (e.g., variety of mixtures or blends of PLA and aPHA, and optionally filler materials).

In accordance with certain embodiments of the invention, the polymeric melt composition includes the additive component, in which the additive component includes a filler material, such as those described and disclosed herein. For example, the filler material may comprise a plurality of particulates dispersed throughout the polymer component.

The method, in accordance with certain embodiments of the invention, may further comprise incrementally stretching the first film layer or film (e.g., a multilayer film as described and disclosed herein) in a machine direction and/or a cross-direction. For instance, the step of incrementally stretching may impart pores dispersed throughout a body or a thickness of the first film layer or film (e.g., a multilayer film as described and disclosed herein). Alternatively, the method may be devoid of an incremental stretching operation.

### EXAMPLES

The present disclosure is further illustrated by the following examples, which in no way should be construed as being limiting. That is, the specific features described in the following examples are merely illustrative and not limiting.

A variety of bio-based compostable films and a few comparative polyethylene based films were produced and subjected to testing to evaluate the physical properties of each film as shown in Table 2. The bottom portion of Table 2 provides the basic constituents and blend ratios used in making each film. For instance, Blend 1 includes a PLA, aPHA, and calcium carbonate as a filler, while Blend 2 only includes PLA and aPHA. The composition labeled “PE-Blend” is a traditionally used polyethylene resin used in the formation of films.

The following test methods were used:
Basis Weight (gsm): ASTM D3776.
Breathability-MOCON (g/m²/24 hours): INDA IST 70.4 (08).
Opacity (%): ASTM D1003.
Tensile Strength/Elongation: ASTM D882.

TABLE 2

| | Bio1 | | STD1 | | Bio2 | | Bio3 | |
|---|---|---|---|---|---|---|---|---|
| | M16- | Bio1-A | M16- | STD1-A | M16- | Bio2-A | M16- | Bio3-A |
| | 5119 | 5115/.05 | 5136A | 5136/.05 | 5120 | 5116/0.05 | 5121 | 5117/.05 |
| CaCO3 | 30% | 30% | 30% | 30% | 15% | 15% | 7.5% | 7.5% |
| TiO2 | 0 | 0 | 2.5 | 2.5 | 0 | 0 | 0 | 0 |
| PHA | 25% | 25% | — | — | 35% | 35% | 40.0% | 40.0% |
| PLA | 45% | 45% | — | — | 50% | 50% | 52.5% | 52.5% |
| Total | 100% | 100% | — | — | 100% | 100% | 100% | 100% |
| (Bio + CaCO3) | | | | | | | | |
| Intermeshed | — | Y | — | Y | — | Y | — | Y |
| BW (gsm) | 25.4 | 26.8 | 24.3 | 21.1 | 26.5 | 22.6 | 22.9 | 23.0 |
| MOCON | 814 | 1908 | 77 | 260 | 1203 | 1941 | 1384 | 1651 |
| Opacity (%) | 27.7 | 51.9 | DNT | DNT | 21.7 | 31.6 | 16.5 | 23.4 |
| 5% MD (g/in) | 943 | 982 | | | 1257 | 797 | 959 | 775 |
| 10% MD (g/in) | 897 | 1101 | | | 1208 | 990 | 967 | 1128 |
| 25% MD (g/in) | 871 | 1124 | | | 1142 | 1064 | 1116 | 1226 |
| MD @ Brk | 966 | 1595 | | | 2002 | 2021 | 1711 | 2471 |
| (g/in) | | | | | | | | |
| MD-El @ Brk | 111 | 107 | | | 169 | 102 | 147 | 100 |
| (%) | | | | | | | | |
| 5% CD (g/in) | 638 | 473 | | | 604 | 353 | 315 | 381 |
| 10% CD (g/in) | 633 | 740 | | | 613 | 622 | 561 | 434 |
| 25% CD (g/in) | 622 | 956 | | | 589 | 667 | 539 | 516 |
| CD @ Brk | 652 | 887 | | | 754 | 773 | 605 | 586 |
| (g/in) | | | | | | | | |
| CD-El @ Brk | 77 | 46 | | | 170 | 81 | 117 | 42 |
| (%) | | | | | | | | |
| % PHA in | 36% | | | | 41% | | 43% | |
| Matrix | | | | | | | | |
| Blend 1 | 100 | 100 | 0 | 0 | 50 | 50 | 25 | 25 |
| PLA/PHA/CaCO3 | | | | | | | | |
| Blend 2 | 0 | 0 | 0 | 0 | 50 | 50 | 75 | 75 |
| PLA/PHA | | | | | | | | |
| PE Blend | 0 | 0 | 67.5 | 67.5 | 0 | 0 | 0 | 0 |

The data from Table 2 highlight a few points of interest for the production of breathable films for healthcare and hygiene applications. For instance, example “Bio 1” exhibits a large breathability rating of over 800 MOCON (g/m²/24 hours) per INDA IST 70.4 (08), despite not being subjected to incremental stretching (e.g., activation/intermeshed). By comparison, “STD 1”, which was formed from polyethylene and had the same amount of filler, had a breathability rating of below 80 MOCON (g/m²/24 hours) per INDA IST 70.4 (08) (e.g., effectively non-breathable). In fact, “STD 1-A”, which had the same composition as “STD 1” but was subjected to activation, only had a breathability rating of 260 MOCON (g/m²/24 hours) per INDA IST 70.4 (08). In this regard, “STD 1-A” had a breathability significantly less than the non-activated film of “Bio 1”. Additionally, examples, “Bio 2” and “Bio 2-A” illustrated improved breathability despite including half the amount of filler (whether subjected to activation/intermeshing). Each of these examples, however, included a higher percentage of aPHA. This trend was further evidenced by examples “Bio 3” and “Bio 3-A”.

These non-limiting examples, for instance, illustrate the desirable physical properties associated bio-based compostable films in accordance with certain embodiments of the invention. In this regard, such bio-based compostable films may replace several traditional films and/or laminates currently employed in a wide range of hygiene and healthcare products.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A compostable film, comprising:
at least a first layer comprising (i) a polymer component comprising (a) one or more polylatic acid (PLA) polymers, and (b) one or more amorphous polyhydroxyalkonate (aPHA) polymers; and optionally (ii) an additive component;
wherein the first film layer has water vapor transmission rate (WVTR) of at least about 500 MOCON (g/m²/24 hours) per INDA IST 70.4 (08); and
wherein the polymer component and/or the first layer has a bio-based carbon content from 75 to 100% by weight per ASTM D6866.

2. The film of claim 1, wherein the first layer includes the additive component, and the additive component comprises filler material comprising a plurality of particulates dispersed throughout the polymer component.

3. The film of claim 2, wherein the filler material comprises a plurality of organic and/or inorganic particulates.

4. The film according to claim 3, wherein the filler material is inherently or rendered less polar than the one or more PLA polymers and/or the one or more aPHA polymers.

5. The film of claim 4, wherein the filler material comprises a surface coating disposed thereon that renders the filler material less polar than the one or more PLA polymers and/or the one or more aPHA polymers.

6. The film of claim 1, wherein the first layer is devoid of a filler material.

7. The film according to claim 1, wherein the one or more PLA polymers comprises from about 30 to about 80% by weight of the polymer component.

8. The film according to claim 1, wherein the one or more aPHA polymers comprises from about 10 to about 70% by weight of the polymer component.

9. The film according to claim 1, wherein the film is a monolayer film consisting of the first layer.

10. The film according to claim 1, wherein the film is a multilayer film including the first layer, and wherein the first layer is located directly or indirectly between a first outermost layer and a second outermost layer.

11. The film of claim 10, wherein the first outermost layer and/or the second outermost layer comprise (i) a respective polymer component comprising (a) one or more polylatic acid (PLA) polymers, and (b) one or more polyhydroxyalkonate (aPHA) polymers; and optionally (ii) a respective additive component.

12. The film according to claim 1, wherein the film has a hydrohead from about 80 to about 1000 mbar determined per EN 20811.

13. An article, comprising:
(i) a backsheet comprising a compostable film according to claim 1;
(ii) a liquid permeable top sheet; and
(iii) an absorbent core, wherein the absorbent core is located directly or indirectly between the top sheet and the backsheet.

14. A protective article, comprising: a compostable film according to claim 1, wherein the protective article comprises a drape, a garment, or a portion of a garment.

15. A method of forming a compostable film, comprising:
(A) forming a polymeric melt composition comprising (i) a polymer component comprising (a) one or more polylatic acid (PLA) polymers, and (b) one or more polyhydroxyalkonate (aPHA) polymers; and optionally (ii) an additive component;
(B) forming at least a first film layer from the polymeric melt composition, such as by a cast film process or a blown film process.

16. The method of claim 15, wherein the polymeric melt composition includes that additive component, and wherein the additive component includes filler material comprising a plurality of particulates dispersed throughout the polymer component.

17. The method according to claim 16, further comprising incrementally stretching the first film layer in a machine direction and/or a cross-direction.

18. The method according to claim 15, wherein the method is devoid of an incremental stretching operation.

19. A laminate, comprising:
(i) a compostable film according to claim 1; and
(ii) a substrate;
wherein the compostable film is directly or indirectly bonded to the substrate.

20. The laminate of claim 19, wherein the substrate comprises at least one woven fabric and/or at least one nonwoven fabric.
